(19) United States
(12) Patent Application Publication
(10) Pub. No.: US 2023/0021321 A1
(43) Pub. Date: Jan. 26, 2023

(54) POSITION LOCATING SYSTEM, MARINE VESSEL, AND TRAILER FOR MARINE VESSEL

(71) Applicant: YAMAHA HATSUDOKI KABUSHIKI KAISHA, Iwata-shi (JP)

(72) Inventor: Hiroshi INOUE, Shizuoka (JP)

(21) Appl. No.: 17/835,264

(22) Filed: Jun. 8, 2022

(30) Foreign Application Priority Data
Jul. 15, 2021 (JP) 2021-116970

(51) Int. Cl. G06T 7/73; G01S 5/18; H04R 1/40; H04R 3/00; H04N 5/33

(52) U.S. Cl. CPC G06T 7/73; G01S 5/18; H04R 1/406; H04R 3/005; H04N 5/33; G01J 5/0859

(57) ABSTRACT

A position locating system that locates relative position information between a marine vessel and a trailer includes a wave signal generator located on a first object that is one of the marine vessel and the trailer to emit wave signals from at least three different positions having known relative positional relationships with each other, a wave signal receiver located a second object that is the other of the marine vessel and the trailer to receive the wave signal emitted from each of the positions of the wave signal generator, and a position locator configured or programmed to locate relative position information between the marine vessel and the trailer that includes at least a direction of the second object as viewed from the first object based on the wave signal from each of the positions received by the wave signal receiver.

### CROSS REFERENCE TO RELATED APPLICATIONS

This application claims the benefit of priority to Japanese Patent Application No. 2021-116970, filed on Jul. 15, 2021. The entire contents of this application are hereby incorporated herein by reference.

### BACKGROUND OF THE INVENTION

### 1. Field of the Invention

The present invention relates to a position locating system, a marine vessel, and a trailer for a marine vessel that locate a relative position between objects.

### 2. Description of the Related Art

Mainly in order to smoothly perform landing of a small marine vessel and departure of the small marine vessel from the water surface, a technique that locates relative position information between a trailer and the marine vessel is known. International Publication No. WO 2016/163559 discloses a technique that obtains position information of a trailer and controls a propulsion device to perform detachment and attachment of a hull.

In the technique disclosed in International Publication No. WO 2016/163559, a plurality of transmitters is disposed on the trailer, a receiving unit is disposed on the hull, a distance between the trailer and the hull is obtained based on the strength of a signal received by the receiving unit, and the hull's own direction with respect to the trailer is obtained based on the direction of the signal. In addition, in the technique disclosed in International Publication No. WO 2016/163559, a camera such as a stereo camera, an infrared camera, or a TOF (Time of Flight) camera is disposed on the hull, and the above distance and the hull's own direction are obtained based on three-dimensional images picked up by the camera.

However, since there are few specifications mounted on the camera disclosed in International Publication No. WO 2016/163559, it is desired to propose a position locating method other than the method disclosed in International Publication No. WO 2016/163559 as an option.

### SUMMARY OF THE INVENTION

Preferred embodiments of the present invention provide position locating systems, marine vessels, and trailers for marine vessels that are each able to locate relative position information between the marine vessels and the trailers.

According to a preferred embodiment of the present invention, a position locating system includes a wave signal generator located on a first object that is one of a marine vessel and a trailer for the marine vessel to emit wave signals from at least three different positions having known relative positional relationships with each other, a wave signal receiver located on a second object that is the other of the marine vessel and the trailer to receive the wave signal emitted from each of the positions of the wave signal generator, and a position locator configured or programmed to locate relative position information between the marine vessel and the trailer that includes at least a direction of the second object as viewed from the first object based on the wave signal from each of the positions received by the wave signal receiver.

According to another preferred embodiment of the present invention, a marine vessel that is the first object or the second object in the position locating system includes the position locator in the position locating system.

According to another preferred embodiment of the present invention, a trailer for a marine vessel that is the first object or the second object in the position locating system includes the position locator in the position locating system.

According to preferred embodiments of the present invention, the wave signals, which are emitted from at least three different positions having known relative positional relationships with each other in the wave signal generator located on the first object, are received by the wave signal receiver located on the second object. Based on the wave signal from each of the positions received by the wave signal receiver, the relative position information between the marine vessel and the trailer that includes at least the direction of the second object as viewed from the first object is located by the position locator. As a result, it is possible to locate the relative position information between the marine vessel and the trailer.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a side view that shows an example of a trailer system to which a position locating system according to a first preferred embodiment of the present invention is applied.

FIG. 2 is a top view that shows the example of the trailer system.

FIG. 3 is a block diagram of the trailer system.

FIG. 4 is a schematic top view of the trailer system that shows the arrangement of a wave signal generating unit and a wave signal receiving unit.

FIGS. 5A and 5B are diagrams that show examples of an image picked up by a camera, and FIG. 5C is a schematic view of LEDs as viewed from a vertical direction.

FIG. 6 is a schematic top view of a trailer system that shows the arrangement of a wave signal generating unit and a wave signal receiving unit in a second preferred embodiment of the present invention.

FIG. 7 is a timing chart that shows sound signal generation and sound signal reception.

FIG. 8 is a schematic top view of a trailer system that shows the arrangement of a wave signal generating unit and a wave signal receiving unit in a third preferred embodiment of the present invention.

### DETAILED DESCRIPTION OF THE PREFERRED EMBODIMENTS

Hereinafter, preferred embodiments of the present invention will be described with reference to the drawings.

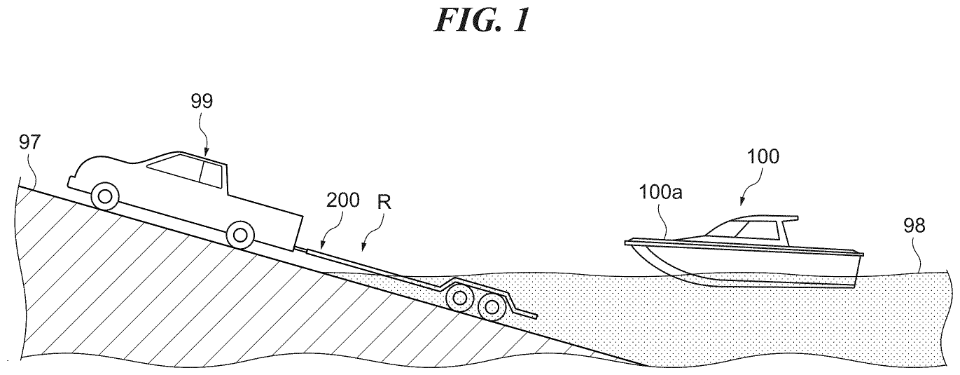

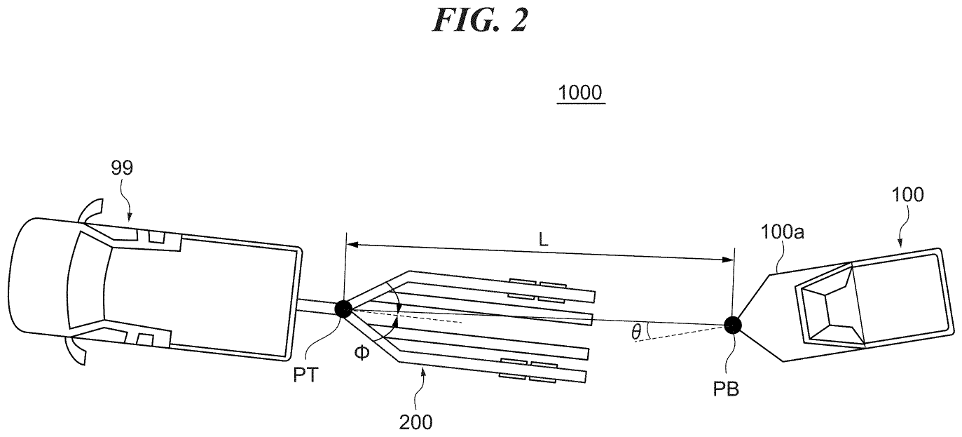

First, a first preferred embodiment of the present invention will be described. FIG. 1 is a side view that shows an example of a trailer system to which a position locating system according to the first preferred embodiment of the present invention is applied. FIG. 2 is a top view that shows the example of the trailer system. A trailer system 1000 includes a marine vessel 100 and a trailer 200 that loads the marine vessel 100. The trailer 200 is a trailer for a marine vessel towed by a vehicle 99 operated by a driver. The marine vessel 100 is, for example, a so-called jet boat.

The trailer system 1000 allows not only the marine vessel 100 to be detached from the trailer 200 and but also the marine vessel 100 to be attached to the trailer 200. An inclined portion (a ramp) R that inclines downward toward the bottom of the water is provided on the waterside. When moving the marine vessel 100 from the trailer 200 on land 97 to a water surface 98, that is, when the marine vessel 100 is detached from the trailer 200 on the land 97 (at the time of detachment), as shown in FIG. 1, the driver drives the vehicle 99 to move the trailer 200 to the inclined portion R. When switching to an automatic trailer mode, the marine vessel 100 automatically moves in a direction away from the trailer 200. As a result, detachment work of detaching the marine vessel 100 from the trailer 200 is automatically performed.

Further, when moving the marine vessel 100 from the water surface 98 to the trailer 200 on the land 97, that is, when the marine vessel 100 is attached to the trailer 200 on the land 97 (at the time of attachment), first, the driver moves the trailer 200 to the inclined portion R. When switching to the automatic trailer mode, the marine vessel 100 is automatically maneuvered and moves in a direction toward the trailer 200. As a result, attachment work of attaching the marine vessel 100 to the trailer 200 is automatically performed. Specific work of automatic detachment and automatic attachment can be realized by a publicly known method such as the method disclosed in International Publication No. WO 2016/163559.

It should be noted that it is efficient to automatically perform mainly the attachment work described above after a control unit 101 functioning as a position locating unit locates “relative position information” between the marine vessel 100 and the trailer 200. Further, it is not essential that the marine vessel 100 is automatically detached from or attached to the trailer 200.

The “relative position information” is defined as quantities when viewed from above as shown in FIG. 2, and includes a distance L, a marine vessel direction φ, and a trailer direction θ. It is assumed that reference positions necessary to define the relative position information are a reference position PT on the trailer 200 and a reference position PB on the marine vessel 100. The reference position PT may be any portion of the trailer 200 (any position at the trailer 200), and the reference position PB may be any portion of the marine vessel 100 (any position at the marine vessel 100).

The distance L is a distance between the trailer 200 (a first object) and the marine vessel 100 (a second object). That is, the distance L is a linear distance between the reference position PT and the reference position PB. The marine vessel direction φ is a direction of the marine vessel 100 as viewed from the trailer 200. The trailer direction θ is a direction of the trailer 200 as viewed from the marine vessel 100.

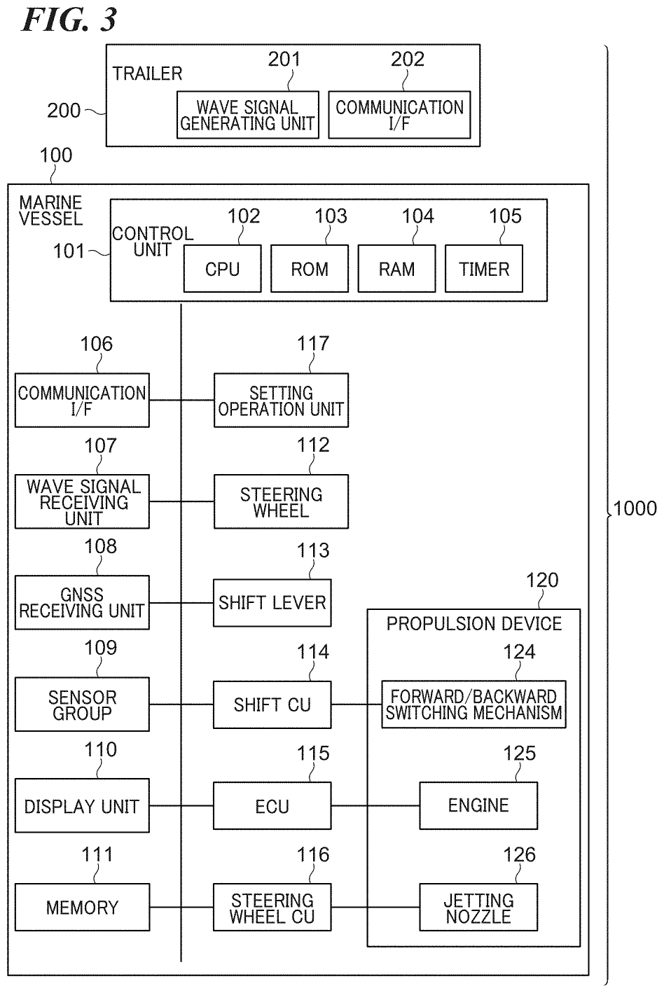

FIG. 3 is a block diagram of the trailer system 1000. The position locating system according to the first preferred embodiment of the present invention is mainly realized by the control unit 101, a wave signal generating unit 201, and a wave signal receiving unit 107.

The marine vessel 100 includes a hull 100a (see FIGS. 1 and 2) and a propulsion device 120 provided on the hull 100a. The marine vessel 100 obtains a propulsive force by ejecting a jet flow of water with the propulsion device 120.

The propulsion device 120 includes an engine 125 that generates a drive force, a forward/backward switching mechanism 124 that transmits the drive force generated by the engine 125 in an adjusted state, and a jetting nozzle 126 that ejects the jet flow of water. In addition, the marine vessel 100 includes an impeller (not shown) to which the drive force generated by the engine 125 is transmitted via the forward/backward switching mechanism 124. The propulsion device 120 generates the jet flow from the jetting nozzle 126 by rotating the impeller by the drive force. Further, the marine vessel 100 adjusts a traveling direction of the marine vessel 100 by changing an ejecting direction of the jet flow from the jetting nozzle 126 generated by the rotation of the impeller.

The marine vessel 100 includes the control unit 101, an ECU (Engine Control Unit) 115, a shift CU (Control Unit) 114, and a steering wheel CU 116. The control unit 101 controls the entire marine vessel 100 including the propulsion device 120. The control unit 101 includes a CPU (Central Processing Unit) 102, a ROM (Read Only Memory) 103, a RAM (Random Access Memory) 104, and a timer 105. The ROM 103 stores control programs. The CPU 102 realizes various kinds of control processes by expanding the control programs, which are stored in the ROM 103, on the RAM 104 and executing them. The RAM 104 provides a working area for the CPU 102 to execute the control programs.

The ECU 115, the shift CU 114, and the steering wheel CU 116 control the engine 125, the forward/backward switching mechanism 124, and the jetting nozzle 126, respectively, based on instructions from the control unit 101.

The marine vessel 100 includes a sensor group 109. The sensor group 109 includes a tidal current sensor, a wind speed sensor, a hook sensor, a water landing sensor, an acceleration sensor, a speed sensor, and an angular speed sensor (none of which are shown). The hook sensor detects that a hook of the trailer 200 is hung on the hull 100a. The water landing sensor detects that the jetting nozzle 126 of the propulsion device 120 is located in the water. The acceleration sensor detects a posture of the hull 100a by detecting an inclination of the hull 100a in addition to detecting an acceleration of the hull 100a. The speed sensor and the angular speed sensor detect a speed (a hull speed) and an angular speed of the hull 100a, respectively.

The hull 100a of the marine vessel 100 is provided with a steering wheel 112 and a shift lever 113. The control unit 101 controls the ejecting direction of the jet flow ejected from the jetting nozzle 126 via the steering wheel CU 116 based on a rotation angle of the operated steering wheel 112. Further, the control unit 101 performs a control to change the forward/backward switching mechanism 124 via the shift CU 114 based on a position of the operated shift lever 113.

The marine vessel 100 includes a memory 111, a display unit 110, a setting operation unit 117, a communication I/F (interface) 106, the wave signal receiving unit 107, and a GNSS (Global Navigation Satellite System) receiving unit 108. The memory 111 is a non-volatile storage medium. The display unit 110 includes a display and displays various kinds of information based on the instructions from the control unit 101. The setting operation unit 117 includes an operation piece that performs operations related to marine vessel maneuvering, a setting operation piece that performs various kinds of settings, and an input operation piece that inputs various kinds of instructions (none of which are shown).

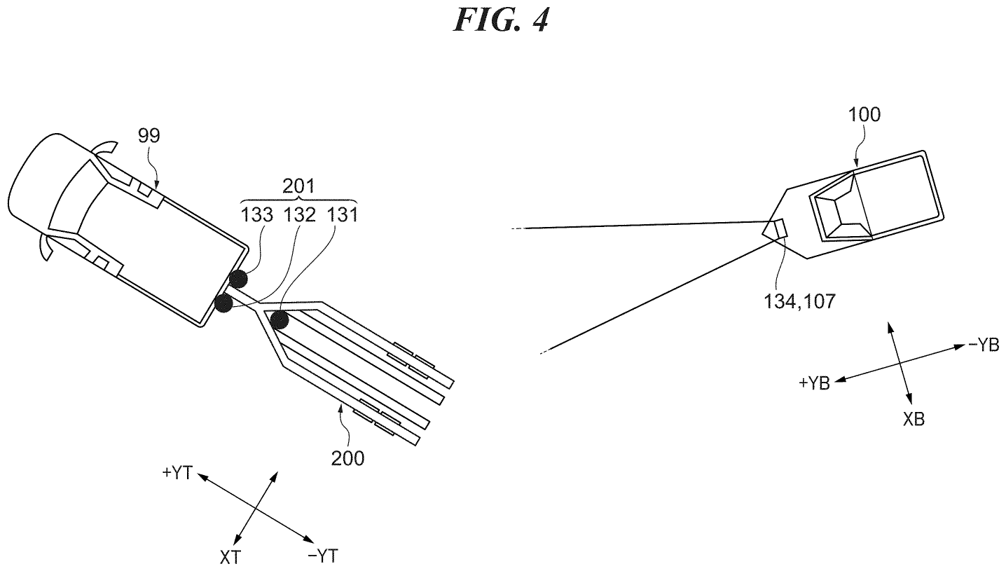

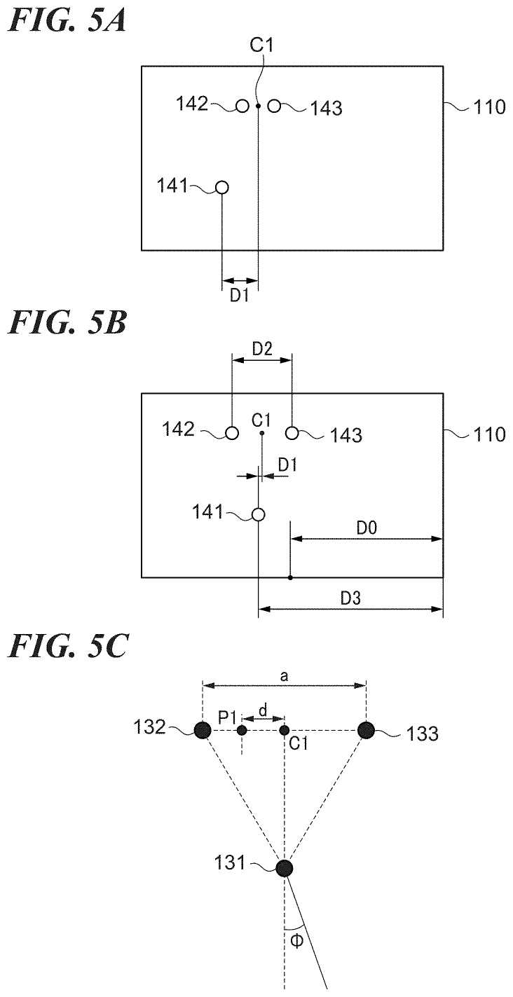

The communication I/F 106 communicates wirelessly or by wire with an external apparatus. The GNSS receiving unit 108 periodically receives a GNSS signal from a GNSS satellite. The wave signal receiving unit 107 will be described with reference to FIGS. 4, 5A, 5B and 5C. The signals received by the wave signal receiving unit 107 and the GNSS receiving unit 108 are supplied to the control unit 101.

The trailer 200 includes the wave signal generating unit 201 and a communication I/F 202. The communication I/F 202 communicates wirelessly or by wire with the external apparatus. The communication I/F 202 also communicates with the communication I/F 106. It should be noted that a communication method between the marine vessel 100 and the trailer 200 does not matter.

The wave signal generating unit 201 and the wave signal receiving unit 107 in the first preferred embodiment of the present invention will be described. FIG. 4 is a schematic top view of the trailer system 1000 that shows the arrangement of the wave signal generating unit 201 and the wave signal receiving unit 107.

The wave signal generating unit 201 located on the trailer 200 emits wave signals from at least three different positions having known relative positional relationships with respect to each other. Specifically, in the first preferred embodiment, three LEDs (light emitting diodes), that is, a first LED 131, a second LED 132, and a third LED 133, are used as the wave signal generating unit 201. Relative three-dimensional coordinates (the relative positional relationships) of other LEDs based on a certain LED are known. For example, an arrangement position of the second LED 132 (a second position) and an arrangement position of the third LED 133 (a third position) are known with respect to an arrangement position of the first LED 131 (a first position). In the first preferred embodiment, the wave signals are optical signals, for example, infrared light.

On the other hand, in the first preferred embodiment, a camera 134 (an imaging pickup apparatus) is used as the wave signal receiving unit 107 provided on the marine vessel 100. The camera 134 is an infrared camera that receives the optical signal emitted from each of the positions of the wave signal generating unit 201 in an imaging pickup range. In the first preferred embodiment, as an example, the arrangement position of the first LED 131 is set as the reference position PT (see FIG. 2), and an arrangement position of the camera 134 is set as the reference position PB.

Directions are defined for convenience based on a case that the trailer 200 is on a horizontal plane. A longitudinal direction of the trailer 200 is set as a YT direction, especially the front is set as a +YT direction and the rear is set as a −YT direction. The YT direction corresponds to a detachment and attachment direction of the marine vessel 100. Further, a crosswise direction of the trailer 200 is set as an XT direction. A front-to-rear direction of the marine vessel 100 is set as a YB direction, especially the front is set as a +YB direction and the rear is set as a −YB direction. Further, a crosswise direction of the marine vessel 100 is set as an XB direction. The camera 134 is located at the front portion of the hull 100a, and the +YB direction (the front) is set as an imaging pickup direction.

In the case that the trailer 200 is on the horizontal plane, the LEDs 131, 132, and 133 do not line up in a straight line when viewed from a vertical direction. With respect to the first LED 131, the LEDs 132 and 133 are located not only at different positions in the YT direction (a front-to-rear direction of the trailer 200) but also at different positions in the vertical direction. Further, the second LED 132 and the third LED 133 are located at different positions in the XT direction (the crosswise direction of the trailer 200). As an example, the LEDs 132 and 133 are located at positions higher than the LED 131 in the +YT direction. The LEDs 132 and 133 are located at positions common to each other in the YT direction.

FIGS. 5A and 5B are diagrams that show examples of an image picked up by the camera 134 in “a position locating process” that locates the relative position information. The picked-up image is displayed on the display unit 110.

“The position locating process” is carried out by the following procedure. First, the driver of the vehicle 99 moves the trailer 200 to the inclined portion R, and starts lighting the LEDs 131, 132, and 133. It should be noted that the LEDs 131, 132, and 133 blink in a specific pattern so as to make it easier to distinguish them from other light emitting objects. A marine vessel operator instructs the control unit 101 to start the position locating process via the setting operation unit 117. As a result, the camera 134 starts imaging pickup.

Next, the marine vessel operator maneuvers the marine vessel 100 so as to become an orientation in which the imaging pickup range includes three LEDs 131, 132, and 133. The control unit 101 generates a picked-up image including the LEDs 131, 132, and 133 as a subject, and displays the picked-up image on the display unit 110 as shown in FIGS. 5A and 5B. When the control unit 101 judges that all of the LEDs 131, 132, and 133 are included in the picked-up image, the control unit 101 extracts bright spots from the picked-up image. The bright spot corresponds to each position of the LEDs 131, 132, and 133 within the screen, and is a position having a higher brightness than the surroundings.

Next, the control unit 101 locates the “relative position information” based on positions of the bright spots within the image, and the relative positional relationships among the LEDs 131, 132, and 133 described above. The located relative position information is outputted by displaying on the display unit 110 or by voice, and is stored in the memory 111. Further, the relative position information is updated at any time during the execution of the position locating process. Moreover, in order to locate the relative position information, it is not essential for the control unit 101 to display the picked-up image on the display unit 110, and the control unit 101 may extract the bright spots by an internal process.

An example of locating the relative position information based on the extracted bright spots will be described with reference to FIGS. 5A and 5B. First, in the picked-up images shown in FIGS. 5A and 5B, bright spots 141, 142, and 143 correspond to the positions of the LEDs 131, 132, and 133 as viewed from the camera 134 (that is, in the imaging pickup range), respectively.

The control unit 101 locates the trailer direction θ based on a position of the bright spot 141 in a left/right direction. When the trailer 200 is located directly in front of the marine vessel 100 (the +YB direction), since the trailer direction θ becomes “0”, the bright spot 141 is located in the middle in the left/right direction within the screen. A distance DO from the right edge within the screen to the intermediate position in the left/right direction is known. Since the angle of view is known, a correspondence relationship between a difference between a distance D3 from the right edge to the position of the bright spot 141 and the distance D0, and the trailer direction θ is also known. For example, in the example shown in FIG. 5B, the control unit 101 is able to locate the trailer direction θ based on the distance D3 from the right edge to the position of the bright spot 141 and the distance D0. It should be noted that known values and known correspondence relationships, including those described below, are stored in the ROM 103 in advance.

FIG. 5C is a schematic view of the LEDs 131, 132, and 133 as viewed from the vertical direction. When viewed from the vertical direction, it is assumed that a triangle having the LEDs 131, 132, and 133 as vertices is an equilateral triangle having a side length of “a”.

The control unit 101 locates the marine vessel direction φ as follows. First, as shown in FIG. 5B, the control unit 101 obtains an intermediate position C1 between the bright spot 142 and the bright spot 143 within the image. Next, the control unit 101 obtains a distance D1 between the bright spot 141 and the intermediate position C1 in the left/right direction. Further, the control unit 101 obtains a distance D2 in the left/right direction between the bright spot 142 and the bright spot 143 within the image. When the marine vessel 100 is located directly behind the trailer 200 (in the −YT direction), the marine vessel direction φ becomes “0”.

The control unit 101 is able to locate the marine vessel direction φ based on the distance D1 and the distance D2. As shown in FIG. 5C, it is assumed that P1 is a point not only on the extension of the LED 131 but also on a line segment connecting the LED 132 and the LED 133 when viewed from the marine vessel 100. It is assumed that a distance d is a distance between the point P1 on the line segment connecting the LED 132 and the LED 133, and the intermediate position C1. For the marine vessel direction ϕ, ϕ=arctan{d/(a\sqrt{ }3/2)} holds. For the distance d, d=D1/D2 holds. Therefore, the marine vessel direction φ is calculated by ϕ=arctan{(D1/D2)/(a\sqrt{ }3/2)}.

The control unit 101 locates the distance L as follows. First, as shown in FIG. 5B, the control unit 101 obtains the distance D2 in the left/right direction between the bright spot 142 and the bright spot 143 within the image. The apparent distance D2 within the image becomes larger as the distance L is shorter if the marine vessel direction φ is constant, and becomes larger as the marine vessel direction φ is closer to 0 if the distance L is constant. The correspondence relationship among the distance D2, the marine vessel direction φ, and the distance L is known. Therefore, the control unit 101 is able to locate the distance L based on the distance D2 and the marine vessel direction φ. As an example, in the case of the arrangement of the LEDs 131, 132, and 133 shown in FIG. 4, the distance L is calculated by L=a coefficient K×the distance D2/cosφ. The coefficient K is a constant of proportionality between the distance D2 and the distance L when φ=0.

The relative position information (the distance L, the marine vessel direction φ, and the trailer direction θ) located in this way is used in the case that the marine vessel 100 is attached to the trailer 200 or other cases.

According to the first preferred embodiment, the wave signal generating unit 201 provided on the trailer 200 emits the wave signals from at least three different positions having known relative positional relationships with each other. The relative position information is located based on the wave signal from each position received by the wave signal receiving unit 107 provided on the marine vessel 100. Specifically, the control unit 101 extracts the bright spots from an image obtained by the camera 134, which is the wave signal receiving unit 107, picking up the optical signals emitted from the LEDs 131, 132, and 133, which is the wave signal generating unit 201. Then, the control unit 101 locates the relative position information based on the positions of the bright spots within the image and the above relative positional relationships. Thus, the trailer direction θ, the marine vessel direction φ, and the distance L are able to be located as the relative position information between the marine vessel 100 and the trailer 200.

Further, in the case that the trailer 200 is on the horizontal plane, the LEDs 131, 132, and 133 do not line up in a straight line when viewed from the vertical direction. With respect to the first LED 131, the LEDs 132 and 133 are located at different positions in the front-to-rear direction. Further, the LEDs 132 and 133 are located at different positions in the crosswise direction from each other. Thus, it is possible to easily calculate the trailer direction θ, the marine vessel direction φ, and the distance L.

With respect to the first LED 131, the LEDs 132 and 133 are located at different positions in the vertical direction. This makes it difficult for the bright spot corresponding to the LED 131 and the bright spots corresponding to the LEDs 132 and 133 to overlap within the picked-up image, and makes it easy to distinguish them. Therefore, it is possible to significantly reduce or prevent erroneous extraction of the bright spots and enhance the accuracy of locating the relative position information.

It is not essential that the heights of the LEDs 131, 132, and 133 are different, and the LEDs 131, 132, and 133 may be arranged on the same plane. Even in this case, when the trailer 200 is moved to the inclined portion R, since the LEDs 132 and 133 are usually located at higher positions than the LED 131, it is easy to distinguish the bright spots corresponding to the LEDs 131, 132, and 133.

Since the LEDs 131, 132, and 133 emit infrared light, it is possible to significantly reduce or prevent the influence of disturbances. Since the LEDs 131, 132, and 133 blink in the specific pattern, they are easily distinguished from other light emitting objects, and as a result, it is also possible to enhance the accuracy of locating the relative position information. It is not essential that the optical signals are infrared light and that the LEDs 131, 132, and 133 blink.

Instead of using the LEDs 131, 132, and 133, predetermined markers may be arranged at the same arrangement positions as the LEDs 131, 132, and 133, and the relative position information is located from an image picked up so as to include these markers as a subject. In this case, the control unit 101 is able to locate the relative position information by, for example, extracting three feature points corresponding to the markers within the picked-up image and performing a calculation process in the same manner as in the case of the bright spots.

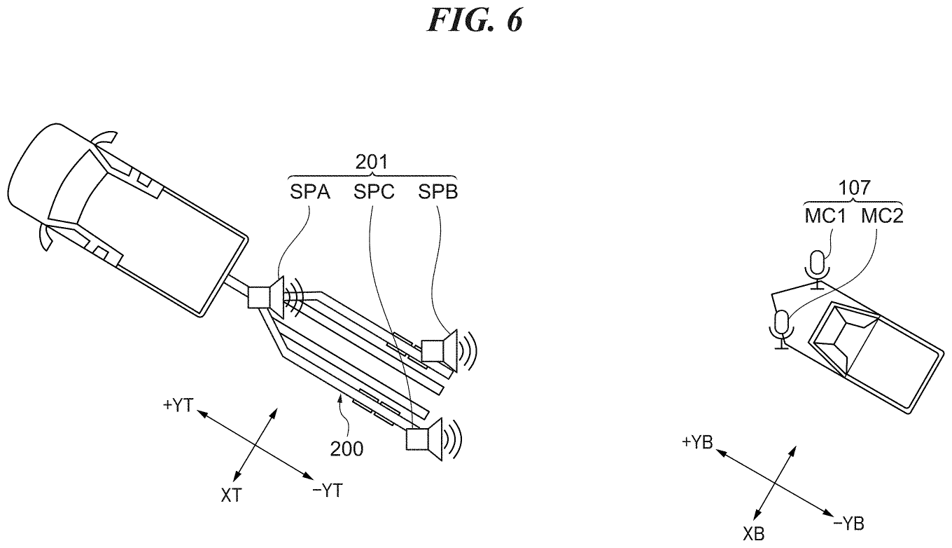

Next, a second preferred embodiment of the present invention will be described. FIG. 6 is a schematic top view of a trailer system 1000 that shows the arrangement of a wave signal generating unit 201 and a wave signal receiving unit 107 in the second preferred embodiment of the present invention. In the second preferred embodiment, components used as the wave signal generating unit 201 and the wave signal receiving unit 107 are different from those of the first preferred embodiment, and accordingly, the method of locating the relative position information is also different from that of the first preferred embodiment. Other configurations of the second preferred embodiment are the same as those of the first preferred embodiment.

In the second preferred embodiment, three speakers SPA, SPB, and SPC, which are sound generating devices, are used as the wave signal generating unit 201. Relative three-dimensional coordinates (the relative positional relationships) of other speakers (for example, the speaker SPB and SPC) based on a certain speaker (for example, the speaker SPA) are known. In the second preferred embodiment, the wave signals are sound signals, for example, ultrasonic signals.

On the other hand, in the second preferred embodiment, two microphones (hereinafter referred to as “microphones MC1 and MC2”) are used as the wave signal receiving unit 107 provided on the marine vessel 100. The microphones MC1 and MC2 receive the sound signal emitted from each of the positions of the wave signal generating unit 201. In the second preferred embodiment, as an example, an arrangement position of the speaker SPA is set as the reference position PT (see FIG. 1), and an arrangement position of the microphone MC1 is set as the reference position PB.

In the case that the trailer 200 is on the horizontal plane, heights of the speakers SPA, SPB, and SPC in the vertical direction are substantially the same. Positions of the speakers SPA, SPB, and SPC as viewed from the vertical direction are different from each other. Further, positions of the microphones MC1 and MC2 as viewed from the vertical direction are different from each other.

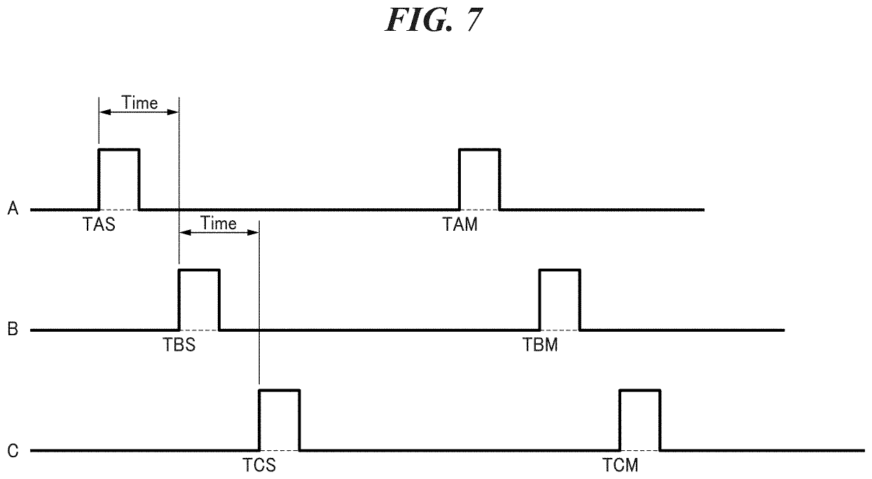

FIG. 7 is a timing chart that shows sound signal generation by the speakers SPA, SPB, and SPC and sound signal reception by the microphones MC1 and MC2. In FIG. 7, a horizontal axis indicates the elapse of time. The microphones MC1 and MC2 receive the sound signals emitted from the speakers SPA, SPB, and SPC, respectively. FIG. 7 shows reception times of the sound signals by the microphone MC1 as a representative.

Generation times of the sound signals from respective positions of the wave signal generating unit 201 are different from each other. By shifting sound generation timings, it becomes easy for the microphones MC1 and MC2 to distinguish the sound generation sources, and it is possible to significantly reduce or prevent erroneous locating. Specifically, the sound signals are generated in the order of the speakers SPA, SPB, and SPC at intervals of a predetermined time (for example, about 20 ms). In order to easily distinguish the sound generation sources, the predetermined time is set to a time longer than a required time for the sound to travel a distance between the adjacent speakers.

As shown in FIG. 7, the generation times of the sound signals in the speakers SPA, SPB, and SPC are times TAS, TBS, and TCS, respectively. It is assumed that the sound signal is generated in a pulse shape, and the generation time of the sound signal is defined as a rising time of the pulse. The reception times of the sound signals emitted from the speakers SPA, SPB, and SPC are times TAM, TBM, and TCM, respectively.

As described below, the control unit 101 locates the positions of the microphones MC1 and MC2 based on the generation times (the times TAS, TBS, and TCS) of the sound signals from respective positions of the wave signal generating unit 201, the reception times (the times TAM, TBM, and TCM) of the sound signals by the microphones MC1 and MC2, and the above relative positional relationships. The positions of the microphones MC1 and MC2 are located, for example, as two-dimensional coordinates on a relative horizontal plane with respect to the speaker SPA. Then, the control unit 101 locates the relative position information (the trailer direction θ, the marine vessel direction φ, and the distance L) based on the positions of the microphones MC1 and MC2 that are located.

In “the position locating process” of the second preferred embodiment, the driver positions the trailer 200 on the inclined portion R and generates the sound signals from the speakers SPA, SPB, and SPC. The marine vessel operator instructs the control unit 101 to start the position locating process. As a result, the microphones MC1 and MC2 start receiving the sound signals. The control unit 101 records the reception times of the sound signals. The generation of the sound signals may be periodically and repeatedly performed, and the control unit 101 may use an average value of the reception times of a plurality of times.

First, respective coordinates are defined as follows. It is assumed that coordinates of the microphones MC1 and MC2 to be obtained are (x, y). It is assumed that coordinates of the speaker SPA on the horizontal plane are (xA, yA). It is assumed that coordinates of the speakers SPB and SPC are (xB, yB) and (xC, yC), respectively. Based on the coordinates (xA, yA), the coordinates (xB, yB) and (xC, yC) are known. It is assumed that the speed of sound (constant) is V. The times TAM, TBM, and TCM are measured values. The times TAS, TBS, and TCS are unknown, but time intervals among them are known.

Representatively, the coordinates (x, y) of the microphone MC1 are calculated based on the following simultaneous equations (1) to (3) and by using the reception times TAM, TBM, and TCM by the microphone MC1. Here, “\hat{ }2” means squared.

(XA−x)\hat{ }2+(yA−y)\hat{ }2=(V\hat{ }2)·(TAM−TAS)\hat{ }2 (1)

(XB−x)\hat{ }2+(yB−y)\hat{ }2=(V\hat{ }2)·(TBM−TBS)\hat{ }2 (2)

(XC−x)\hat{ }2+(yC−y)\hat{ }2=(V\hat{ }2)·(TCM−TCS)\hat{ }2 (3)

Further, the coordinates of the microphone MC2 are located (obtained) based on the known coordinates of the microphone MC1. Alternatively, the coordinates of the microphone MC2 may be calculated based on the above-described simultaneous equations (1) to (3) and by using the times TAM, TBM, and TCM by the microphone MC2. In this way, respective coordinates (x, y) of the microphones MC1 and MC2 with respect to the speaker SPA are calculated. Therefore, on the horizontal plane, the positional relationship between any one of the microphones MC1 and MC2, and any one of the speakers SPA, SPB, and SPC becomes known.

Since the arrangement position of the speaker SPA is set as the reference position PT and the arrangement position of the microphone MC1 is set as the reference position PB, the control unit 101 is able to locate (obtain) the distance L based on the position information between the speaker SPA and the microphone MC1. Further, the trailer direction θ and the marine vessel direction φ are also able to be located (obtained) based on the positional relationships among the speakers SPA, SPB, and SPC, and the positional relationship between the microphones MC1 and MC2.

The reference position PB may be set at a predetermined position on the marine vessel 100, such as at the center position between the microphone MC1 and the microphone MC2. Even in that case, since the predetermined position of the marine vessel 100 becomes known based on the positions of the microphones MC1 and MC2, it is possible to locate (obtain) the trailer direction θ, the marine vessel direction φ, and the distance L.

According to the second preferred embodiment, the control unit 101 performs a control so that the microphones MC1 and MC2 provided on the marine vessel 100 receive the sound signals emitted from the speakers SPA, SPB, and SPC provided on the trailer 200. The control unit 101 locates (obtains) the positions of the microphones MC1 and MC2 based on the generation times (the times TAS, TBS, and TCS) of the sound signals, the reception times (the times TAM, TBM, and TCM) of the sound signals by the microphones MC1 and MC2, and the above relative positional relationships. Then, the control unit 101 locates (obtains) the relative position information based on the positions of the microphones MC1 and MC2 that are located (obtained). Therefore, the same effects as that of the first preferred embodiment are obtained with respect to locating (obtaining) the trailer direction θ, the marine vessel direction φ, and the distance L as the relative position information between the marine vessel 100 and the trailer 200.

Since the generation times (the times TAS, TBS, and TCS) of the sound signals are different from each other, it becomes easy to distinguish which speaker is the generation source of the received sound signal, and it is possible to significantly reduce or prevent erroneous locating (erroneous obtaining) of the relative position information. It is not essential to shift generation timings. From the viewpoint of making it easy to distinguish the generation sources, for example, frequencies of the sounds emitted from the speakers may be different from each other.

Since the sound signals are preferably ultrasonic signals, it is possible to significantly reduce or prevent disturbances and locate the relative position information with high accuracy. It should be noted that it is not essential that the sound signals are ultrasonic signals.

Since the heights of the speakers SPA, SPB, and SPC in the vertical direction are substantially the same, it is possible to locate the relative position information with high accuracy without considering the vertical distance component at the time of calculation, and as a result, the load is reduced. It should be noted that it is not essential that the heights of the speakers SPA, SPB, and SPC in the vertical direction are the same. Further, if the relative position information is located in consideration of the difference in the vertical arrangement heights of the speakers SPA, SPB, and SPC, a term corresponding to a component in the vertical direction may be provided in the above-described simultaneous equations (1) to (3) to obtain the three-dimensional coordinates of the microphones MC1 and MC2.

Alternatively, a fourth speaker whose position in the vertical direction is different from those of the speakers SPA, SPB, and SPC may be provided. Furthermore, the relative position information may be located based on simultaneous equations in which an equation corresponding to the fourth speaker is added to the above-described simultaneous equations (1) to (3).

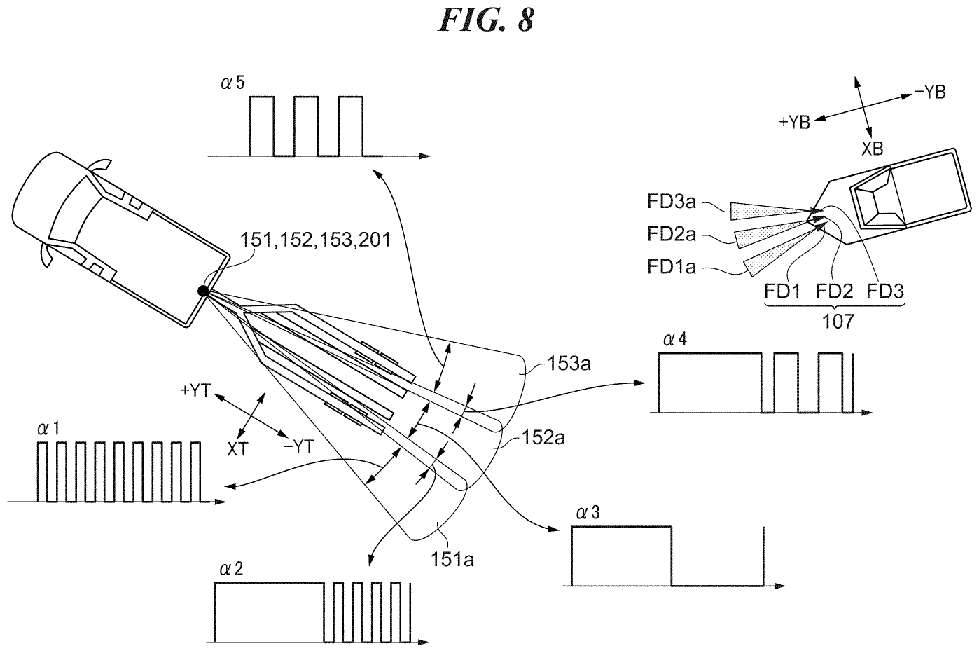

Next, a third preferred embodiment of the present invention will be described. FIG. 8 is a schematic top view of a trailer system 1000 that shows the arrangement of a wave signal generating unit 201 and a wave signal receiving unit 107 in the third preferred embodiment of the present invention. In the third preferred embodiment, components used as the wave signal generating unit 201 and the wave signal receiving unit 107 are different from those of the first preferred embodiment, and accordingly, the method of locating the relative position information is also different from that of the first preferred embodiment. Other configurations of the third preferred embodiment are the same as those of the first preferred embodiment.

In the third preferred embodiment, three directional LEDs 151, 152, and 153 are used as the wave signal generating unit 201. The directional LEDs 151, 152, and 153, which are light emitting units, are grouped at substantially the same position. In the third preferred embodiment, the wave signals are optical signals, preferably infrared light. The optical signals emitted from the directional LEDs 151, 152, and 153 have directivity and are directed in different directions from each other. As shown in FIG. 8, due to the difference in their directivity, irradiation regions of the optical signals emitted from the LEDs 151, 152, and 153 are irradiation regions 151a, 152a, and 153a. Blinking patterns of the optical signals emitted from the LEDs 151, 152, and 153 are different from each other.

On the other hand, in the third preferred embodiment, three photodiodes, which are light receiving units (hereinafter referred to as “photodiodes FD1, FD2, and FD3”), are used as the wave signal receiving unit 107 provided on the marine vessel 100. The photodiodes FD1, FD2, and FD3 have light receiving ranges in different directions from each other. As shown in FIG. 8, the light receiving ranges of the photodiodes FD1, FD2, and FD3 are set to light receiving ranges FD1a, FD2a, and FD3a, respectively. Preferably, the light receiving ranges FD1a, FD2a, and FD3a do not overlap each other.

The irradiation regions 151a, 152a, and 153a adjacent to each other have regions overlapping each other. Therefore, as shown in FIG. 8, by distinguishing the non-overlapping region and the overlapping region, it is possible to divide the regions into five regions α1 to α5. That is, respective individual regions of the irradiation regions 151a, 152a, and 153a are the regions α1, α3, and α5. The overlapping region of the irradiation regions 151a and 152a is the region α2, and the overlapping region of the irradiation regions 152a and 153a is the region α4.

In “the position locating process” of the third preferred embodiment, the driver positions the trailer 200 on the inclined portion R and generates the optical signals from the LEDs 151, 152, and 153. The marine vessel operator instructs the control unit 101 to start the position locating process. As a result, the photodiodes FD1, FD2, and FD3 start receiving the optical signals.

When the marine vessel 100 is substantially oriented in a direction in which the trailer 200 is present, the optical signals emitted from the wave signal generating unit 201 are received by any one of the photodiodes FD1, FD2, and FD3. The control unit 101 locates the marine vessel direction φ depending on that which of the LEDs 151, 152, and 153 is the generation source of the optical signal received by any one of the photodiodes FD1, FD2, and FD3. As described above, since the regions are divided into five regions (the regions α1 to α5), the marine vessel direction φ is able to be located in five stages depending on which generation source of the optical signal belongs to which of the five regions. Each of the regions α1 to α5 is associated with each of φ1 to φ5, which are five stages of the marine vessel direction φ. For example, in the case that the generation source of the optical signal belongs to the region α2, the marine vessel direction φ is located to be φ2.

In order to make it easy to distinguish the regions α1 to α5, the blinking patterns of the optical signals emitted from the LEDs 151, 152, and 153 are different from each other, and phases of the optical signals emitted from the LEDs 151, 152, and 153 are shifted from each other. As shown in FIG. 8, the number of light pulses within a certain period of time is highest for the LED 151 and lowest for the LED 152. Therefore, in the regions α1, α3, and α5, the optical signal with one type of fixed blinking pattern is received. Further, since the phases are shifted from each other, in the region α2, the fine blinking pattern by the LED 151 and the rough blinking pattern by the LED 152 are alternately received. Similarly, in the region α4, the rough blinking pattern by the LED 152 and the medium blinking pattern by the LED 153 are alternately received. In this way, it is possible to distinguish the regions α1 to α5 from the repetition of the blinking pattern.

On the other hand, the control unit 101 locates the trailer direction θ depending on which optical signals emitted from the wave signal generating unit 201 are received by which of the photodiodes FD1, FD2, and FD3. The photodiodes FD1, FD2, and FD3 are associated with θ1, θ2, and θ3, which are the trailer directions θ, respectively. For example, in the case that the optical signals are received by the photodiode FD2, the trailer directions θ is located to be θ2.

Another example will be described. In the case that the photodiode FD1 enters the irradiation region 151a and the LED 151 enters the light receiving range FD1a of the photodiode FD1, the marine vessel direction φ is located to be φ1, and the trailer directions θ is located to be θ1.

According to the third preferred embodiment, the optical signals having the directivity are emitted from the LEDs 151, 152, and 153, and the marine vessel direction φ is located by the generation source of the optical signal received by the photodiodes FD1, FD2, and FD3. In particular, since the blinking patterns of the optical signals emitted from the LEDs 151, 152, and 153 are different from each other and the phases of the optical signals emitted from the LEDs 151, 152, and 153 are shifted from each other, it is possible to divide the regions into the finer regions α1 to α5 and locate the marine vessel direction φ.

The trailer direction θ is located depending on which optical signals are received by which of the photodiodes FD1, FD2, and FD3.

Therefore, the same effects as that of the first preferred embodiment are obtained with respect to locating (obtaining) the trailer direction θ and the marine vessel direction φ as the relative position information between the marine vessel 100 and the trailer 200.

Since the LEDs 151, 152, and 153 emit infrared light, it is possible to significantly reduce or prevent the influence of disturbances. Moreover, it is not essential that the optical signals are infrared light. Further, it is not essential that the LEDs 151, 152, and 153 blink. For example, the LEDs 151, 152, and 153 may emit light in different colors from each other so that the generation sources are able to be distinguished.

It should be noted that the number of the directional LEDs and the number of the photodiodes are not limited to three. In case it is desired to more finely locate the marine vessel direction φ and the trailer direction θ, the number of the directional LEDs and the number of the photodiodes may be increased. Further, in the case that the effect of obtaining the marine vessel direction φ or the trailer direction θ is not required, the number of the directional LEDs or the number of the photodiodes may be one.

In each of the first preferred embodiment, the second preferred embodiment, and the third preferred embodiment described above, the configuration that the control unit 101 of the marine vessel 100 has a function of the position locating process which locates the relative position information is used. However, the present invention is not limited to this configuration, and the function of the position locating process may be provided on the trailer 200 or in an external communication device such as a smartphone.

Further, in each of the first preferred embodiment, the second preferred embodiment, and the third preferred embodiment described above, although the wave signal generating unit 201 is provided on the trailer 200 and the wave signal receiving unit 107 is provided on the marine vessel 100, the arrangement positions of the wave signal generating unit 201 and the wave signal receiving unit 107 may be reversed. In other words, such a configuration may be used in which the wave signal generating unit 201 is located on the first object that is one of the marine vessel 100 and the trailer 200, and the wave signal receiving unit 107 is located on the second object that is the other of the marine vessel 100 and the trailer 200.

Also, such a configuration may be used in which the wave signal generating unit 201 is provided on one of a pier and a marine vessel, and the wave signal receiving unit 107 is provided on the other of the pier and the marine vessel. In this case, the wave signal generating unit 201 or the wave signal receiving unit 107 may be located on either the left or right side of the marine vessel. By doing so, it becomes easy to control marine vessel maneuvering such as stopping the marine vessel near the pier based on the relative position information that is located (obtained). Alternatively, the wave signal generating unit 201 may be provided on one marine vessel, and the wave signal receiving unit 107 may be provided on the other marine vessel. By doing so, it becomes easy for one marine vessel to track the other marine vessel.

Although the present invention has been described in detail based on the preferred embodiments described above, the present invention is not limited to these specific preferred embodiments, and various embodiments within the scope not deviating from the gist of the present invention are also included in the present invention. Some of the above-described preferred embodiments may be combined as appropriate.

For example, although the method of the third preferred embodiment is a simple method, the marine vessel direction φ and the trailer direction θ are only able to be approximately located as compared with the first preferred embodiment and the second preferred embodiment. Therefore, a two-step locating method may be used in which the method of the third preferred embodiment is carried out and then the first preferred embodiment or the second preferred embodiment is carried out. That is, the marine vessel operator approximately locates the marine vessel direction φ and the trailer direction θ by the method of the third preferred embodiment, and then based on these location results, the marine vessel operator brings the marine vessel 100 closer to the trailer 200, or moves the marine vessel 100 so as to catch the trailer 200 in front. After that, by carrying out the first preferred embodiment or the second preferred embodiment, the control unit 101 locates the distance L and more accurately locates the marine vessel direction φ and the trailer direction θ.

It should be noted that the present invention is not limited to be applied to jet boats, and the present invention is also able to be applied to various kinds of marine vessels that are propelled by outboard motors, inboard motors, or inboard/outboard motors.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A position locating system comprising:
a wave signal generator located on a first object that is one of a marine vessel and a trailer for the marine vessel to emit wave signals from at least three different positions having known relative positional relationships with each other;
a wave signal receiver located on a second object that is the other of the marine vessel and the trailer to receive the wave signal emitted from each of the at least three positions of the wave signal generator; and
a position locator configured or programmed to locate relative position information between the marine vessel and the trailer that includes at least a direction of the second object as viewed from the first object based on the wave signal from each of the at least three positions received by the wave signal receiver.

2. The position locating system according to claim 1, wherein the wave signals include optical signals, and the wave signal receiver includes an imaging pickup apparatus.

3. The position locating system according to claim 2, wherein
the imaging pickup apparatus generates an image including each of the at least three positions as a subject; and
the position locator is configured or programmed to extract bright spots from the image generated and locate the relative position information based on positions of the bright spots within the image and the relative positional relationships.

4. The position locating system according to claim 3, wherein the at least three positions include a first position, a second position different in a front-to-rear direction with respect to the first position, and a third position different in a crosswise direction with respect to the second position, and which do not line up in a straight line when viewed from a vertical direction.

5. The position locating system according to claim 4, wherein the position locator is configured or programmed to locate a direction of the first object as viewed from the second object based on a position in a left/right direction of the bright spot corresponding to the first position within the image.

6. The position locating system according to claim 4, wherein the position locator is configured or programmed to locate the direction of the second object as viewed from the first object based on a distance in a left/right direction between an intermediate position between the bright spot corresponding to the second position and the bright spot corresponding to the third position within the image, and the bright spot corresponding to the first position within the image.

7. The position locating system according to claim 6, wherein the position locator is configured or programmed to locate a distance between the first object and the second object based on a distance in the left/right direction between the bright spot corresponding to the second position and the bright spot corresponding to the third position within the image, and the direction of the second object as viewed from the first object.

8. The position locating system according to claim 4, wherein the second position and the third position are different positions in a vertical direction with respect to the first position.

9. The position locating system according to claim 2, wherein the wave signals include infrared light.

10. The position locating system according to claim 9, wherein the wave signal generator blinks the infrared light in a specific pattern.

11. The position locating system according to claim 1, wherein
the wave signals are sound signals; and
the wave signal receiver includes two microphones.

12. The position locating system according to claim 11, wherein
each of the two microphones receives the sound signal emitted from each of the at least three positions; and
the position locator is configured or programmed to locate the relative position information based on generation time of each of the sound signals from each of the at least three positions, reception time of each of the sound signals by the two microphones, and the relative positional relationships.

13. The position locating system according to claim 12, wherein the position locator is configured or programmed to:
locate positions of the two microphones based on the generation time of each of the sound signals from each of the at least three positions, the reception time of each of the sound signals by the two microphones, and the relative positional relationships; and
locate a distance between the first object and the second object, a direction of the first object as viewed from the second object, and the direction of the second object as viewed from the first object as the relative position information between the marine vessel and the trailer based on the positions of the two microphones.

14. The position locating system according to claim 11, wherein the wave signal generator makes the generation times of the sound signals, which are emitted from the at least three positions, different from each other.

15. The position locating system according to claim 11, wherein heights in a vertical direction of the at least three positions of the wave signal generator are the same or substantially the same.

16. The position locating system according to claim 11, wherein the sound signals include ultrasonic signals.

17. The position locating system according to claim 1, wherein
the wave signals emitted from each of the at least three positions are optical signals that have directivity and are directed in different directions from each other;
the wave signal receiver includes a light receiver; and
the position locator is configured or programmed to locate the direction of the second object as viewed from the first object depending on which source of the optical signal received by the light receiver corresponds to which of the at least three positions.

18. The position locating system according to claim 17, wherein
irradiation regions of the optical signals emitted from the at least three positions, which are directed in directions adjacent to each other, have regions overlapping each other; and
blinking patterns of the optical signals are different from each other.

19. The position locating system according to claim 17, wherein,
the wave signal receiver includes two or more light receivers that have light receiving ranges in different directions from each other; and
the position locator is configured or programmed to locate a direction of the first object as viewed from the second object by the light receiver, which has received the optical signal, among the two or more light receivers.

20. The position locating system according to claim 17, wherein the wave signals include infrared light.

21. The position locating system according to claim 1, further comprising:
a plurality of light emitters located on the first object to emit optical signals that have directivity and are directed in different directions from each other; and
a light receiver located on the second object to receive the optical signals emitted from the plurality of light emitters; wherein
the position locator is configured or programmed to locate the direction of the second object as viewed from the first object depending on which optical signal received by the light receiver corresponds to which of the plurality of light emitting units.

22. The position locating system according to claim 1, wherein the first object is the trailer and the second object is the marine vessel.

23. A marine vessel comprising:
the position locating system according to claim 1; wherein
the position locator is located on the marine vessel.

24. A trailer for a marine vessel, the trailer comprising:
the position locating system according to claim 1; wherein
the position locator is located on the trailer.
